(19) United States
(12) Patent Application Publication
(10) Pub. No.: US 2013/0207899 A1
(43) Pub. Date: Aug. 15, 2013

(54) TOUCH-SENSING DISPLAY DEVICE

(71) Applicants: Po-Hsien Wang, Tai Chung City (TW); Yu-Ting Chen, Chai Yi City (TW); Chen-Hao Su, Tai Chung County (TW); Chung-Hsien Li, Tai Chung City (TW)

(72) Inventors: Po-Hsien Wang, Tai Chung City (TW); Yu-Ting Chen, Chai Yi City (TW); Chen-Hao Su, Tai Chung County (TW); Chung-Hsien Li, Tai Chung City (TW)

(21) Appl. No.: 13/369,908

(22) Filed: Feb. 9, 2012

(51) Int. Cl. G06F 3/041

(52) U.S. Cl. 345/173

(57) ABSTRACT

A touch-sensitive display device includes a plurality of gate lines, a plurality of data lines, and a plurality of touch-sensing lines. Each of the gate lines receives at least one first gate drive signal and at least one second gate drive signal. Each of the data lines receives at least one pixel data signal. The touch-sensing lines is overlapped with and spaced apart from the gate lines. The gate lines are divided into multiple line groups, and each of the line groups includes a plurality of gate lines. Each of the touch-sensing lines receives a sensing signal, and each of the line groups is overlapped with a touch-sensing line to form multiple overlapping regions that function as a touch-sensing unit.

### BACKGROUND OF THE INVENTION

a. Field of the Invention

The invention relates to a touch-sensitive display device.

b. Description of the Related Art

FIG. 1A shows a schematic diagram illustrating touch-sensing wiring of a conventional touch panel, and FIG. 1B shows a schematic diagram illustrating fabrication processes of the touch panel shown in FIG. 1A. As shown in FIG. 1A and FIG. 1B, the touch panel 100 has an X-axis sensing series 104 and a Y-axis sensing series 106 to sense two-dimensional touch positions. Under the circumstance, the X-axis sensing series 104, a first insulation layer 108, the Y-axis sensing series 106, and a second insulation layer 106 are formed in succession on a transparent substrate 102 to result in complicated and a considerable number of fabrication processes. However, the current trend in the design of an in-cell touch panel is to integrate and reduce the number of fabrication processes. Therefore, in case the fabrication processes of the touch panel shown in FIG. 1B are used in an in-cell touch panel, the production yields are reduced and the fabrication costs are increased.

### BRIEF SUMMARY OF THE INVENTION

The invention provides a touch-sensitive display device having simplified fabrication processes, high production yields, and low fabrication costs.

In order to achieve one or a portion of or all of the objects or other objects, one embodiment of the invention provides a touch-sensitive display device having a plurality of gate lines, a plurality of data lines, and a plurality of touch-sensing lines. Each of the gate lines receives at least one first gate drive signal and at least one second gate drive signal. The data lines cross the gate lines, and each of the data lines receives at least one pixel data signal. Two adjacent gate lines are intersected with two adjacent data lines to define the distribution area of a pixel unit. The touch-sensing lines is overlapped with and spaced apart from the gate lines. The gate lines are divided into multiple line groups, and each of the line groups includes a plurality of gate lines. Each of the touch-sensing lines receives a sensing signal, and each of the line groups is overlapped with a touch-sensing line to form multiple overlapping regions that function as a touch-sensing unit. The frame time of each display frame of the touch-sensitive display device has a data write-in period and a touch-sensing period. The first gate drive signal, in the data write-in period, successively drives the gate lines to allow the pixel data signal to be written into the pixel unit. The second gate drive signal, in the touch-sensing period, successively drives each of the line groups at a time to allow each of the touch-sensing units to sense coupling capacitance formed as a result of a touch operation.

In one embodiment, only one gate line is driven at one time by the first gate drive signal in the data write-in period.

In one embodiment, the touch-sensing lines substantially parallel to the data lines and perpendicular to the gate lines.

In one embodiment, the second gate drive signal drives a gate line before the time when the first gate drive signal drives the same gate line. Besides, all gate lines in one of the line groups are driven by the second gate drive signal before the time when all gate lines in the same line group are successively driven by the first gate signal.

In one embodiment, the second gate drive signal is a negative-voltage signal or a positive-voltage signal.

In one embodiment, the first gate drive signal is in a low level in the touch-sensing period.

In one embodiment, the gate lines serve as an X-axis sensing series and the touch-sensing lines serve as a Y-axis sensing series of a touch-sensing structure.

According to another embodiment of the invention, a touch-sensitive display device includes a plurality of gate lines, a plurality of data lines, and a plurality of touch-sensing lines. Each of the gate lines receives at least one display scan signal and at least one coupling signal. The coupling signal is enabled when the display scan signal is in a low level, and the coupling signal drives a gate line before the time when the display scan signal drives the same gate line. The data lines cross the gate lines, and each of the data lines receives at least one pixel data signal. Two adjacent gate lines are intersected with two adjacent data lines to define the distribution area of a pixel unit. The touch-sensing lines is overlapped with and spaced apart from the gate lines, the gate lines are divided into multiple line groups, each of the line groups comprises a plurality of gate lines, and each of the touch-sensing lines receives a sensing signal. Each of the line groups is overlapped with a touch-sensing line to form multiple overlapping regions that function as a touch-sensing unit. The display scan signal successively drives the gate lines to allow the pixel data signal to be written into the pixel unit, and the coupling signal successively drives each of the line groups at a time to allow each of the touch-sensing units to sense coupling capacitance formed as a result of a touch operation.

According to the above embodiments, multiple gate lines are grouped to function as a sensing series with respect to one axis. Therefore, only one sensing series constructed by multiple touch-sensing lines is needed to be formed on a transparent substrate to form a touch-sensing structure. Accordingly, connection wiring and fabrication processes are simplified to improve production yields and reduce fabrication time and costs. Besides, the above embodiments also facilitate the process of integrating touch-sensing functions into an in-cell touch panel.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A shows a schematic diagram illustrating touch-sensing wiring of a conventional touch panel, and FIG. 1B shows a schematic diagram illustrating fabrication processes of the touch panel shown in FIG. 1A.

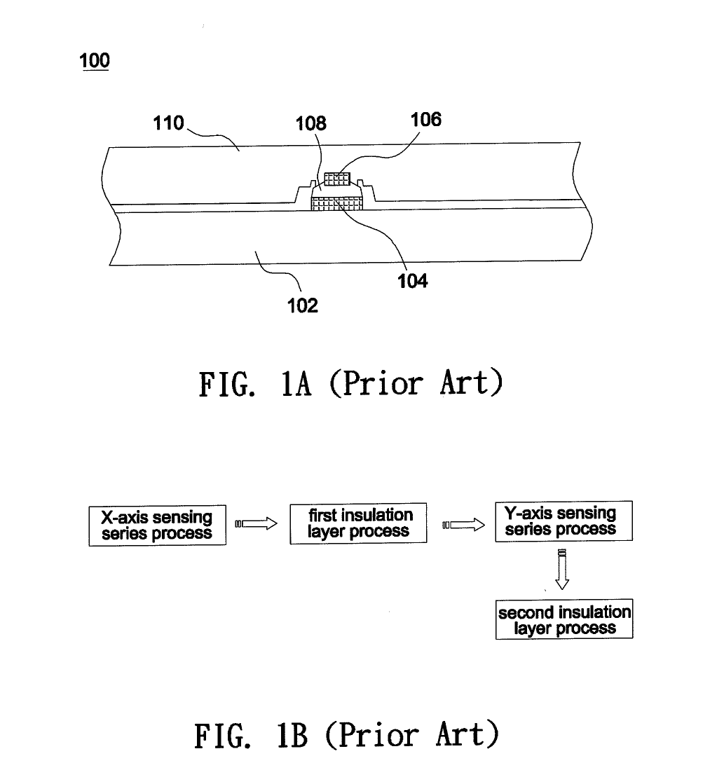

FIG. 2 shows a touch-sensitive display device according to an embodiment of the invention.

FIG. 3 shows a timing diagram of a touch-sensitive display device according to an embodiment of the invention.

FIG. 4A and FIG. 4B show waveform diagrams of a coupling signal according to different embodiments of the invention.

FIG. 5A shows a schematic diagram illustrating touch-sensing wiring of a touch-sensitive display device according to an embodiment of the invention, and FIG. 5B shows a schematic diagram illustrating fabrication processes of the touch touch-sensitive display device shown in FIG. 5A.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

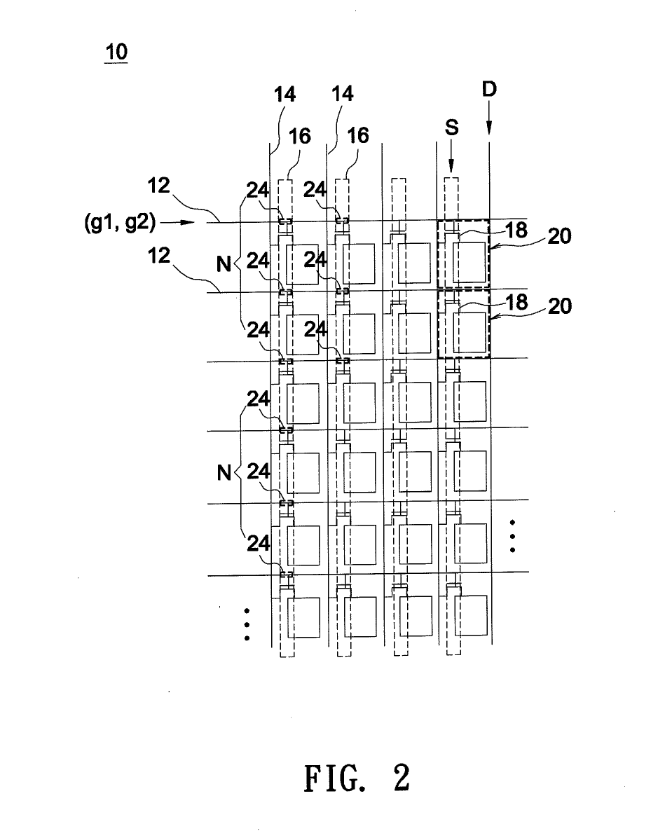

FIG. 2 shows a touch-sensitive display device according to an embodiment of the invention. Referring to FIG. 2, a touch-sensitive display device 10 includes multiple gate lines 12, multiple data lines 14, and multiple touch-sensing lines 16. The data lines 14 cross the gate lines 12, and two adjacent gate lines 12 are intersected with two adjacent data lines 14 to define the distribution area of a pixel unit 20 having at least one thin film transistor (TFT) 18. The touch-sensing lines 16 are overlapped with and spaced apart from the gate lines 12. In one embodiment, each of the touch-sensing lines 16 is substantially parallel to the data lines 14 and perpendicular to the gate lines 12.

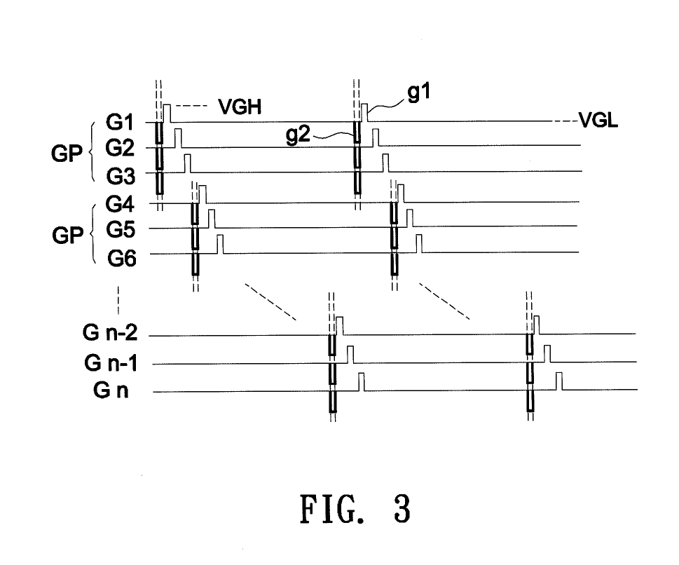

The touch-sensitive display device 10 may perform both image display and touch-sensing operations. During the image display operation, each gate line 12 receives a first gate drive signal g1, and the first gate drive signal g1 successively drives the gate lines 12. Each gate line 12 driven by the first gate drive signal g1 turns on a corresponding TFT 18 to allow the data lines 14 crossing the driven gate line 12 to read at least one pixel data signal D, and the pixel data signal D is transmitted to a liquid crystal capacitor via the TFT 18. During the touch-sensing operation, each gate line 12 receives a second gate drive signal g2, and each touch-sensing line 16 receives a sensing signal S. Referring to both FIG. 2 and FIG. 3, in this embodiment, multiple gate lines 12 are divided into multiple line groups GP, and each line group GP includes multiple gate lines 12. Each line group GP is overlapped with a touch-sensing line 16 to form multiple overlapping regions 24 that function as a touch-sensing unit N. A coupling signal (such as the second gate drive signal g2) used for the touch-sensing operation successively drives the line groups GP (one line group at a time). As shown in FIG. 3, each line group GP includes, for example, three gate lines 12, and thus three gate lines 12 are driven at a time by the second gate drive signal g2, and each touch-sensing unit N includes three overlapping regions 24. According to the above embodiment, since multiple gate lines 12 in one line group GP receive the second gate drive signal g2 at one time, more sufficient coupling capacitance is provided to enhance touch-sensing capability. Certainly, the number of gate lines 12 in each line group GP is not limited and can be selected according to actual demands. The second gate drive signal g2 successively drives the line groups GP to allow each touch-sensing unit N to detect voltage variations due to coupling capacitance that is formed as a result of a touch operation, and detection results are transmitted to a signal processing unit such as an IC (not shown) to therefore sense touch positions.

Please refer to FIG. 3 again, in the touch-sensitive display device 10, the frame time of each display frame includes a data write-in period and a touch-sensing period. In the data write-in period, the first gate drive signal g1 successively drives gate lines G1-Gn to allow pixel data signals D to be written into each pixel unit 20. In the touch-sensing period, the second gate drive signal g2 successively drives the line groups GP (one line group at a time), and each touch-sensing line 16 receives the sensing signal S to allow each touch sensing unit N to detect voltage variations due to coupling capacitance that is formed as a result of a touch operation. In other words, the second gate drive signal g2 is enabled when the first gate drive signal g1 is in a low level (VGL). Further, in this embodiment, the second gate drive signal g2 drives a gate line 12 before the time when the first gate drive signal g1 drives the same gate line 12. More specifically, in this embodiment, all gate lines 12 in one of the line groups GP are driven by the second gate drive signal g2 before the time when all gate lines 12 in the same line group GP are successively driven by the first gate signal 12. That is, pixel data signals D are written into a pixel unit 20 after a corresponding touch-sensing and capacitance coupling operation is finished to hence ensure the second gate drive signal g2 does not affect image display.

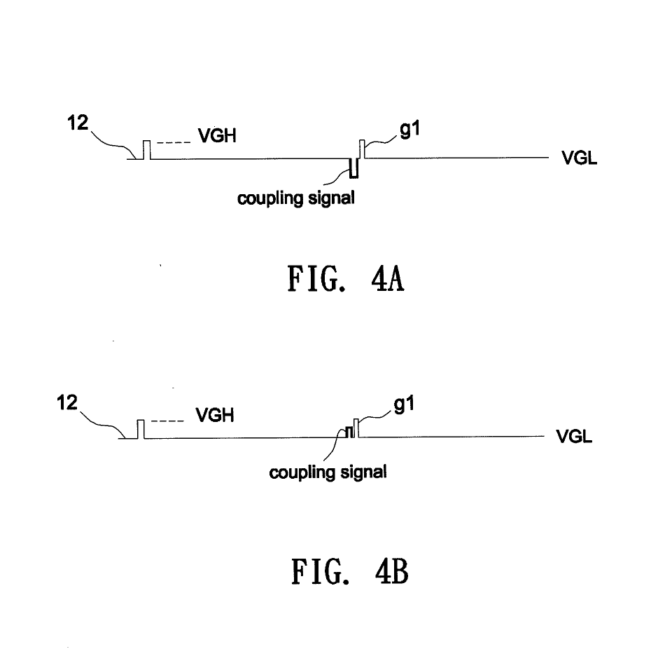

In the above embodiments, the coupling signal used for the touch-sensing operation includes, but is not limited to, a gate drive signal supplied by a gate driver, and different kinds of scan signals supplied by other signal source may be also used. Besides, the coupling signal may be a negative-voltage signal (FIG. 4A) or a positive-voltage signal (FIG. 4B). Further, the voltage level of a coupling signal is preferably selected from a region corresponding to a lower off current in the I-V curve to prevent the TFT 18 from having a low off current during the touch-sensing and capacitance coupling operation. Besides, each touch-sensing line 16 is not limited to have the stripe-shape shown in FIG. 2. The touch-sensing line 16 may be formed by multiple triangular or diamond-shaped transparent electrodes arranged in a direction parallel to an axis (such as the Y-axis).

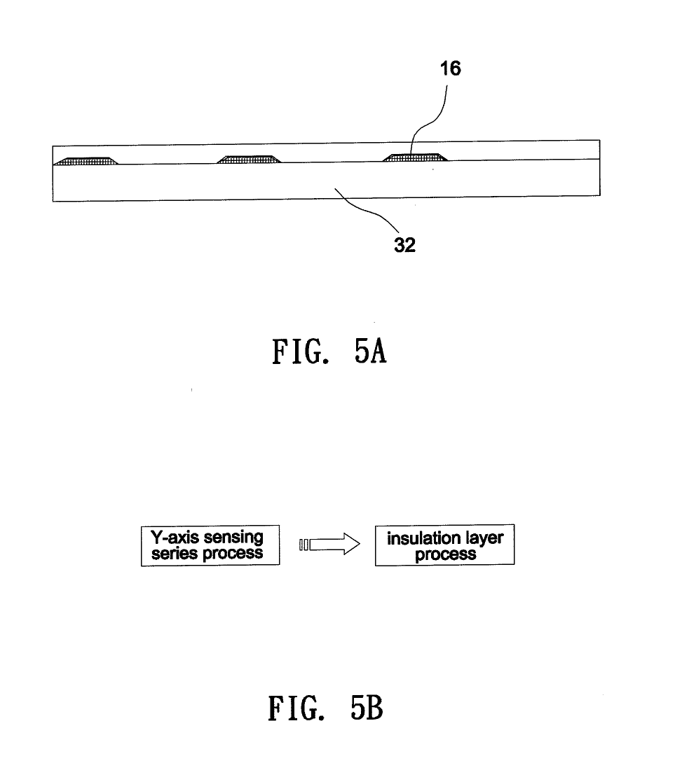

Please refer to both FIG. 5A and FIG. 5B, according to the above embodiments, multiple gate lines 12 are grouped to function as a sensing series with respect to one axis (such as the X-axis sensing series). Therefore, only one sensing series (such as the Y-axis sensing series) constructed by multiple touch-sensing lines 16 is needed to be formed on a transparent substrate 32 to form a touch-sensing structure. Accordingly, connection wiring and fabrication processes are simplified to improve production yields and reduce fabrication time and costs. Besides, the above embodiments also facilitate the process of integrating touch-sensing functions into an in-cell touch panel.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

What is claimed is:

1. A touch-sensitive display device, comprising:
a plurality of gate lines, wherein each of the gate lines receives at least one first gate drive signal and at least one second gate drive signal;
a plurality of data lines crossing the gate lines, wherein each of the data lines receives at least one pixel data signal, and two adjacent gate lines are intersected with two adjacent data lines to define the distribution area of a pixel unit; and
a plurality of touch-sensing lines being overlapped with and spaced apart from the gate lines, wherein the gate lines are divided into multiple line groups, each of the line groups comprises a plurality of gate lines, each of the touch-sensing lines receives a sensing signal, and each of the line groups is overlapped with a touch-sensing line to form multiple overlapping regions that function as a touch-sensing unit;
wherein the frame time of each display frame of the touch-sensitive display device has a data write-in period and a touch-sensing period, the first gate drive signal, in the data write-in period, successively drives the gate lines to allow the pixel data signal to be written into the pixel unit, and the second gate drive signal, in the touch-sensing period, successively drives each of the line groups at a time to allow each of the touch-sensing units to sense coupling capacitance formed as a result of a touch operation.

2. The touch-sensitive display device as claimed in claim 1, wherein, in the data write-in period, only one gate line is driven at one time by the first gate drive signal.

3. The touch-sensitive display device as claimed in claim 1, wherein the touch-sensing lines substantially parallel to the data lines and perpendicular to the gate lines.

4. The touch-sensitive display device as claimed in claim 1, wherein the second gate drive signal drives a gate line before the time when the first gate drive signal drives the same gate line.

5. The touch-sensitive display device as claimed in claim 1, wherein all gate lines in one of the line groups are driven by the second gate drive signal before the time when all gate lines in the same line group are successively driven by the first gate signal.

6. The touch-sensitive display device as claimed in claim 1, wherein the second gate drive signal is a negative-voltage signal or a positive-voltage signal.

7. The touch-sensitive display device as claimed in claim 1, wherein, in the touch-sensing period, the first gate drive signal is in a low level.

8. The touch-sensitive display device as claimed in claim 1, wherein the gate lines serve as an X-axis sensing series and the touch-sensing lines serve as a Y-axis sensing series of a touch-sensing structure.

9. A touch-sensitive display device, comprising:
a plurality of gate lines, wherein each of the gate lines receives at least one display scan signal and at least one coupling signal, the coupling signal is enabled when the display scan signal is in a low level, and the coupling signal drives a gate line before the time when the display scan signal drives the same gate line;
a plurality of data lines crossing the gate lines, wherein each of the data lines receives at least one pixel data signal, and two adjacent gate lines are intersected with two adjacent data lines to define the distribution area of a pixel unit; and
a plurality of touch-sensing lines being overlapped with and spaced apart from the gate lines, wherein the gate lines are divided into multiple line groups, each of the line groups comprises a plurality of gate lines, each of the touch-sensing lines receives a sensing signal, and each of the line groups is overlapped with a touch-sensing line to form multiple overlapping regions that function as a touch-sensing unit;
wherein the display scan signal successively drives the gate lines to allow the pixel data signal to be written into the pixel unit, and the coupling signal successively drives each of the line groups at a time to allow each of the touch-sensing units to sense coupling capacitance formed as a result of a touch operation.

10. The touch-sensitive display device as claimed in claim 9, wherein the touch-sensing lines substantially parallel to the data lines and perpendicular to the gate lines.

11. The touch-sensitive display device as claimed in claim 9, wherein the coupling signal is a negative-voltage signal or a positive-voltage signal.

12. The touch-sensitive display device as claimed in claim 9, wherein the gate lines serve as an X-axis sensing series and the touch-sensing lines serve as a Y-axis sensing series of a touch-sensing structure.

13. The touch-sensitive display device as claimed in claim 9, wherein all gate lines in one of the line groups are driven by the coupling signal before the time when all gate lines in the same line group are successively driven by the display scan signal.
